(19) United States
(12) Patent Application Publication
(10) Pub. No.: US 2011/0256763 A1
(43) Pub. Date: Oct. 20, 2011

(54) MITIGATION OF CROSSTALK RESONANCES IN INTERCONNECTS

(76) Inventors: Jan De Geest, Wetteren (BE); Stefaan Hendrik Jozef Sercu, Wuustwezel (BE); Jonathan E. Buck, Hershey, PA (US); Douglas M. Johnescu, York, PA (US); Stuart C. Stoner, Lewisberry, PA (US); Stephen B. Smith, Mechanicsburg, PA (US)

(21) Appl. No.: 13/081,323

(22) Filed: Apr. 6, 2011

Related U.S. Application Data
(63) Continuation-in-part of application No. 12/974,132, filed on Dec. 21, 2010.
(60) Provisional application No. 61/321,667, filed on Apr. 7, 2010.
(60) Provisional application No. 61/359,272, filed on Jun. 28, 2010.
(60) Provisional application No. 61/359,256, filed on Jun. 28, 2010.

(51) Int. Cl. H01R 13/648; H01R 24/00

(52) U.S. Cl. 439/607.01; 439/626

(57) ABSTRACT

In an electrical connector, a non-grounded, electrically conductive material (such as copper foil or other sheet of metal) may be located adjacent to at least one differential signal pair. An example includes a ring of material that circumscribes a leadframe assembly. Ring-shaped structures placed around, but not in contact with, the signal and ground contacts effectively mitigate cross-talk resonances in the interconnection structure.

### CROSS-REFERENCE TO RELATED APPLICATIONS

This application is a continuation-in-part of U.S. patent application Ser. No. 12/974,132, filed Dec. 21, 2010, and claims priority from provisional U.S. patent application No. 61/321,667, filed Apr. 7, 2010, provisional U.S. patent application No. 61/359,272, filed Jun. 28, 2010, and provisional U.S. patent application No. 61/359,256, Jun. 28, 2010, disclosure of each of which is incorporated herein by reference.

### BACKGROUND

US patent application publication no. 2009/0221165A1 describes an electrical connector that includes a first insulative housing that contains differential signal pairs, ground contacts, and a non-shielding ground coupling assembly. The non-shielding ground coupling assembly shifts a resonance frequency to a higher value as compared to a second electrical connector that is virtually identical to the electrical connector except for the non-shielding ground coupling assembly.

### SUMMARY

In an electrical connector as disclosed herein, a non-grounded, non-shielding electrically conductive material may be located adjacent to at least one differential signal pair and capacitively coupled (but not physically attached) to at least one contact, such as a ground or low frequency signal contact. Such a structure may effectively mitigate resonances in the interconnection structure.

An example of such an electrical connector may include an arrangement of signal contacts and ground contacts. A non-shielding, structure, such as a plate, may be disposed adjacent to the signal contacts and to the ground contacts. Electrically insulative bulks of material such as air or plastic may be disposed between the non-shielding, strip-like structure and the ground or low frequency signal contacts. The non-shielding, strip-like structure makes no physical electrical contact with the signal contacts or the ground/low-frequency signal contacts.

The non-shielding, structure may include a single plate, a pair of parallel plates, or two pairs of parallel plates, which may form a ring structure. The non-shielding structure may include a first plate adjacent to a first of the ground contacts, and a second plate adjacent to a first differential pair of the signal contacts. The non-shielding, structure may include a third plate extending between the first plate and the second plate.

A first distance between the first plate and the first ground contact may be greater than a second distance between the second plate and the first differential pair of signal contacts. A first of the electrically insulative bulks of material may be disposed between the first plate and the first ground contact. Thus, a first capacitance may be provided between the first plate and the first ground contact, while a second capacitance is provided between the second plate and the first differential pair of signal contacts. The first capacitance may be different from the second capacitance.

### BRIEF DESCRIPTION OF THE DRAWINGS

FIGS. 1A and 1B depict an example structure with an ungrounded ground plate that is electrically connected to a leadframe assembly of signal contacts and ground contacts.

FIG. 2 provides a reference structure for calculating parallel non-shielding capacitance.

FIGS. 3A and 3B are cross-sectional and top views of an example structure for improving the signal performance of an electrical connector.

FIG. 4 depicts a leadframe assembly with a single non-shielding structure.

FIG. 5-8 depict leadframe assemblies with various parallel non-shielding structures.

FIG. 9 is a perspective view of an electrical connector including first and second pluralities of leadframe housings;

FIG. 10 is a perspective view of one of the first plurality of leadframe housings illustrated in FIG. 9; and

FIG. 11 is a perspective view of one of the second plurality of leadframe housing illustrated in FIG. 9.

### DETAILED DESCRIPTION

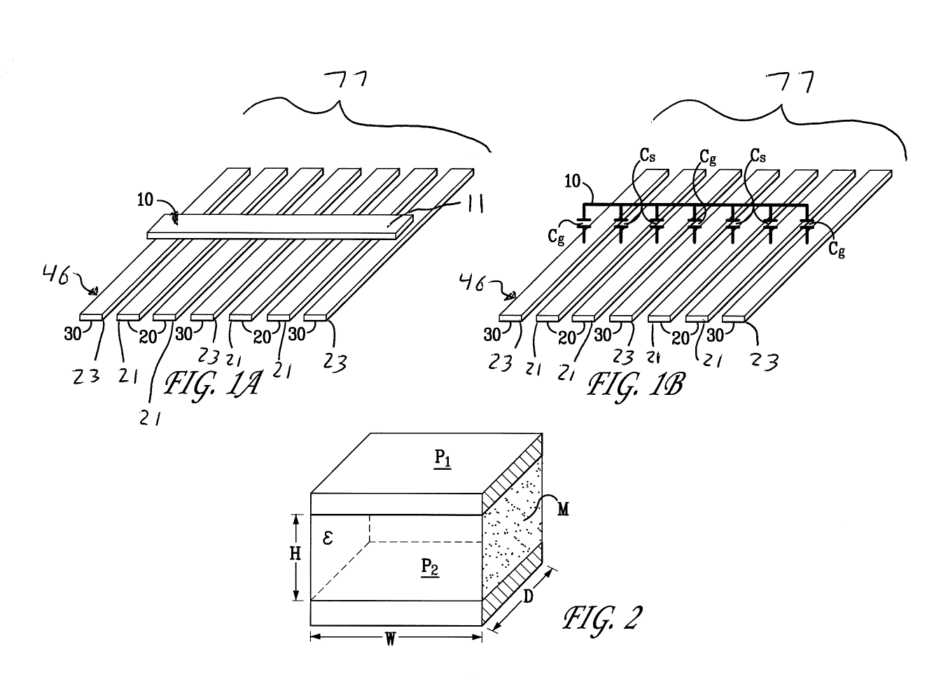

FIGS. 1A and 1B depict an example leadframe assembly 77 for an electrical connector. The leadframe assembly 77 may include a plurality of electrical contacts 46 arranged as an open pinfield. For instance, the electrical contacts 46 can be arranged as a first plurality of electrical contacts 20 which can be configured as signal contacts, and a second plurality of electrical contacts 30 which can be configured as ground contacts. The first and second pluralities of electrical contacts 20 and 30 may be arranged in a column direction or in a row direction. When each of the first plurality of electrical contacts 20 are signal contacts and each of the second plurality of electrical contacts 30 are ground contacts (no signal frequency), the electrical contacts 46 may be arranged in a signal-signal-ground configuration wherein adjacent signal contacts may form differential signal pairs. In general, the leadframe assembly 77 may include any number of first plurality of electrical contacts 20 and any number of second plurality of electrical contacts 30. Alternatively, both the first and second pluralities of electrical contacts 20 and 30 can be configured as a mixture of high frequency signal contacts (between and including about 2 GHz to 20 GHz, such as between and including about 2 GHz to 10 GHz, such as between and including about 4.5 GHz to 10 GHz) and low frequency contacts (less than 2 GHz, such as approximately 0 Hz to 100 MHz and every frequency value in between 0 Hz and 2 GHz, including approximately 0 Hz to approximately 1 MHz), or alternatively configured as desired.

FIG. 1A depicts an electrically ungrounded structure 10 disposed adjacent to at least one of the differential signal pairs. The electrically ungrounded structure 10 may be non-shielding and may be made of an electrically conductive material (such as, for example, a metal or a conductive absorbing material). U.S. Pat. Nos. 6,252,163, 5,334,955, and 4,003,840 disclose ferrite materials that may be suitable for use in connection with the described electrical connectors. The disclosure of each of the foregoing U.S. patents is incorporated herein by references in its entirety. In accordance with one embodiment, the ungrounded structure 10 is conductive, that is, can establish an electrical flow path. For instance, the ungrounded structure 10 can be made from a conductive lossy material, such as carbon-impregnated plastic, and thus can define an electrically conductive magnetic absorbing material. Alternatively, the ungrounded structure 10 can be electrically conductive but non-magnetically absorbing, such as metallic copper. Alternatively still, the ungrounded structure 10 can be magnetically absorbing and electrically non-conductive. For instance, the electrically conductive material of the ungrounded structure 10 can be a ferrite-infused plastic. It should be appreciated that while the ferrite-infused plastic does not cause the ungrounded structure 10 to be electrically conductive, that is establish an electrically conductive flow path for electrons, the ferrite infusion causes the ungrounded structure 10 to be made from a conductive material. Accordingly, as will now be described, the ungrounded structure 10 can be capacitively coupled to at least one such as a plurality of the electrical contacts 46, for instance at least one such as a plurality, up to all, of the second plurality of electrical contacts 30. In accordance with the illustrated embodiment, the ungrounded structure 10 can be configured as a non-shielding substantially planar plate 11, though it should be appreciated that the ungrounded structure 10 can be alternatively configured as desired.

It should be appreciated that when the ungrounded structure 10 is capacitively coupled to the second plurality of electrical contacts 30 and the second plurality of electrical contacts 30 define signal contacts, the electrical contacts 30 can transmit data at lower speeds with respect to the first plurality of electrical contacts 20 while maintaining an acceptable level of cross-talk at or below six percent, multi-active, asynchronous at a 40 pico-second rise time. For the purpose of illustration, the first plurality of electrical contacts 20 are described below as configured as differential signal pairs of contacts 21 and the second plurality of electrical contacts 30 are described below as configured as ground/low frequency signal contacts 23. Thus, an electrical connector can include at least one signal contact 21, such as a high frequency signal contact, and at least one ground or low frequency contact 23 adjacent the at least one signal contact 21.

The ungrounded structure 10 may be located a distance away from, and not make direct physical contact with, any of the signal contacts 21 or ground/low frequency signal contacts 23. The ungrounded structure 10 may be electrically insulated from the signal contacts 21 and ground/low frequency signal contacts 23. In such a structure, a first capacitance, Cg, may be provided between a ground/low frequency signal contact 23 and the ungrounded structure 10, and a second capacitance, Cs, may be provided between a signal contact 21 and the ungrounded structure 10 (see FIG. 1B). Though the ungrounded structure 10 may be depicted herein as a plate for ease of explanation, it should be understood that, in general, the non-grounded, non-shielding electrically conductive material may assume any shape that enables the connector to achieve a desired signal performance.

As shown in FIG. 3A, an electrical connector can be configured with an array of contacts including signal contacts 21 and ground or low frequency signal contacts 23. The array can include a first plurality of electrical contacts 20 comprising a differential signal pair of adjacent signal contacts 21. Each of the first plurality of electrical contacts 20 has a pair of opposed first broadsides and a pair of opposed first edges, the first broadsides each being wider than the first edges. The differential signal pair 21, 21 is configured to carry high frequency signals of about 2 GHz to about 20 GHz, such as about 2 GHz to about 15 GHz, including about 2 GHz to about 10 GHz. A second plurality of electrical contacts 30 may include at least two electrical contacts selected from a group of ground or low frequency signal contacts 23. Each of the second plurality of electrical contacts 30 has a pair of opposed second broadsides and a pair of opposed second edges, the second broadsides each being wider than the second edges. The ground contacts 23 are configured to carry no signal frequency (power or ground) and the low frequency signal contacts (also 23) are configured to carry signal frequencies of approximately between and including about 0 Hz and about 100 MHz. The ungrounded structure 10 may be a magnetic absorbing material that extends over the differential signal pair and the at least two electrical contacts.

In accordance with one embodiment, the magnetic absorbing material does not physically touch the at least two electrical contacts 23, but is capacitively coupled to the two electrical contacts 23. As defined herein, capacitively coupled means that the two electrical contacts 23 are only electrically shorted together when high frequencies from the differential signal pair migrate onto the two electrical contacts 23 and the high frequencies overcome the first capacitive gap, and thus the first capacitance, between each of the two electrical contacts 23 and the magnetic absorbing material. Capacitance can be calculated as εA/d, where ε=8.9×10⁻¹² F/m, A=a broadside width of one of the two electrical contacts, and d=a distance between one of the two electrical contacts and the ungrounded structure 10, such as an electrically conductive magnetic absorbing material.

As shown in FIG. 1B, the second plurality of electrical contacts 30 may include at least one ground or low frequency signal contact 23 that carries a low frequency signal. The first plurality of electrical contacts 30 can include at least one differential signal pair of signal contacts 23 that carries high frequency signals. An ungrounded structure 10, such as a magnetic absorbing material, may extend over the at least one ground or low frequency signal contact 23 and the at least one high frequency signal contact 21 without physically touching the at least one ground or low frequency signal contact 23 or the at least one high frequency signal contact 21. A first capacitive gap is defined between the ungrounded structure 10 and the at least one low frequency signal contact or ground contact 23, such that a first capacitance C_{g} exists between the ungrounded structure 10 and the at least one low frequency signal contact 23 such that the ungrounded structure 10 is capacitively coupled to the at least one (or at least two) low frequency signal contacts or ground contacts 23. The first capacitance C_{g} is can be greater than, for instance at least three times greater than, a second capacitance Cₛ that exists between the ungrounded structure 10 and the at least one high frequency signal contact 21. The first capacitance C_{g} can be about 180 pico-Farads per meter (or more). Without being bounded by theory, a high frequency signal carried by the high frequency signal contact can undesirably radiate or leak to, be received by, or otherwise be intercepted by an adjacent ground contact or low frequency signal contact 23. The high frequency signal can then propagate along the ground contact or low frequency signal contact, through the first capacitive gap, and thus the first capacitance C_{g}, and be transferred to the ungrounded structure 10. However, the first capacitance C_{g} is still large enough to act as an electrical barrier to lower frequency signals. This allows the same electrical contact to be simultaneously behave electrically as a ground contact with respect to undesirable or stray high frequency signals and a signal contact for intentionally propagated low frequency signals. Moreover, at high frequencies, the ground contacts and the low frequency signal contacts are electrically shorted together by the ungrounded structure even though the ground/low frequency signal contacts are not Ohm-metrically connected to one another.

FIG. 2 provides a reference structure for calculating parallel plate capacitance C (not shown). As shown, a first plate P1 may be disposed in parallel with a second plate P2. A dielectric material M may be disposed between the plates P1, P2. Each plate P1, P2 may abut the dielectric material M. Thus, the dielectric material M may fill the three-dimensional space between the plates P1, P2.

The dielectric material M may have a height, H, which is also the distance between the plates P1, P2. The dielectric material M may have a width, W, which may also be the width of each plate P1, P2. The dielectric material M may have a depth, D, which may also be the depth of each plate P1, P2. Thus, the volume, V, of the dielectric material M between the plates P1, P2 may be obtained by V=WDH. The parallel plate capacitance, C, between the plates P1, P2 may be obtained by C=ε₀εWD/H, where ε₀ is the well-known vacuum permitivity constant, and ε is the dielectric constant of the dielectric material M.

Thus, referring again to FIG. 1B, a desired capacitance C_{g}, between the ungrounded structure 10 and the ground/low frequency signal contacts 23 may be provided by providing respective volumes of a dielectric material between the ungrounded structure 10 and the ground/low frequency signal contacts 23. Similarly, a desired capacitance Cₛ, between the ungrounded structure 10 and the signal contacts 21 may be provided by providing respective volumes of a dielectric material between the ungrounded structure 10 and the signal contacts 21.

Referring to FIGS. 3A and 3B, the ungrounded structure 10 can be configured as an ungrounded plate 40 that may span across the signal contacts 21 and ground/low frequency signal contacts 23 of the leadframe assembly 77. Otherwise stated, the ungrounded plate 40 can be angularly offset with respect to the underlying portion of the respective signal contacts 21 and ground/low frequency signal contacts 23. The plate 40 can be non-shielding. The ungrounded plate 40 may be electrically ungrounded. The ungrounded plate 40 may be shaped to avoid physical contact with the signal contacts 21. The ungrounded plate 40 may be physically isolated from the ground/low frequency signal contacts 23 via bulks of electrically insulative material 50, which may be plastic, for example. The bulks of electrically insulative material 50 may be disposed between the ungrounded plate 40 and the ground/low frequency contacts 23. Thus, the ungrounded plate 40 may be located adjacent to at least one of the differential signal pairs (or all of them) without making electrical contact with any of the signal contacts 21. At the same time, the ungrounded plate 40 may be insulated from the adjacent ground/low frequency signal contacts 23.

The ungrounded plate 40 may include a first plate 42 adjacent to a first of the ground/low frequency signal contacts 23, and a second plate 44 adjacent to a first differential pair of the signal contacts 21. The ungrounded plate 40 may include a third plate 46 extending between the first plate 42 and the second plate 44. The ungrounded plate 40 may include a fourth plate 48 extending from the second plate 44.

A first distance, d₁, between the first plate 42 and the adjacent ground/low frequency signal contact 23 may be greater than a second distance, d₂, between the second plate 44 and the differential pair of signal contacts 21. An electrically insulative bulk of material 50 may be disposed between the first plate 42 and the adjacent ground/low frequency signal contact 23. Thus, as described in detail above, a first capacitance, C_{g}, may be provided between the first plate 42 and the adjacent ground/low frequency signal contact 23, while a second capacitance, Cₛ, is provided between the second plate 44 and the differential pair of signal contacts 21. The first capacitance, C_{g}, may be numerically larger than the second capacitance, Cₛ. As shown in FIGS. 3A and 3B, the ground/low frequency signal contacts 23 may be wider than the signal contacts 21 (as measure in a direction along the column).

FIG. 4 depicts a leadframe assembly with a single ungrounded structure 10 configured as a substantially planar plate. As shown in FIG. 4, the ungrounded structure 10 may be an electrically conductive material disposed adjacent to one or more signal contacts 21 and to one or more ground/low frequency signal contacts 23. The electrically conductive material may be formed as a single plate P1 that has two parallel short sides and two parallel elongated sides. As described in detail above, the distance between the plate P1 and the ground/low frequency signal contacts 23, as well as the dielectric material (not shown in FIG. 4) between the plate P1 and the ground/low frequency signal contacts 23, may be selected to provide a capacitance C_{g} between the plate P1 and the ground/low frequency signal contacts 23.

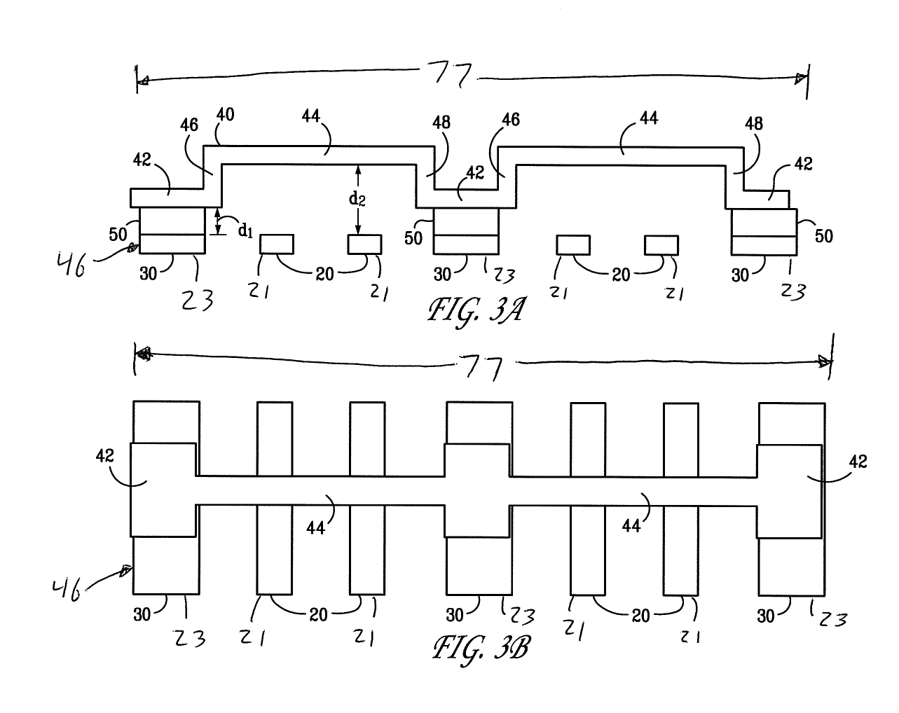

FIG. 5-8 depict leadframe assemblies 8, 8A with various parallel ungrounded structures 10, 10. Such ungrounded structures 10, 10 may have twice the capacitance of a single ungrounded structure 10. This may be valuable if capacitive coupling between the ground/low frequency signal contact 23 and the ungrounded structure 10 is too small for good operation of the connector. Also, a ring structure may have higher coupling to ground/low frequency signal contacts 23 at the edges of the ring if the electrical contact at the edge of the ungrounded structure 10, 10 is a ground/low frequency signal contact.

As shown in FIG. 5, the ungrounded structure 10 may be an electrically conductive material disposed adjacent to one or more signal contacts 21 and to one or more ground/low frequency signal contacts 23. The electrically conductive material may be formed as a pair of parallel, non-shielding plates P1, P2. As described in detail above, the distance between the plate P1 and the ground/low frequency signal contacts 23, as well as the dielectric material (not shown in FIG. 5) between the plate P1 and the ground/low frequency signal contacts 23, may be selected to provide a capacitance C_{g} between the plate P1 and the ground/low frequency signal contacts 23. Similarly, the distance between the plate P2 and the ground/low frequency signal contacts 23, as well as the dielectric material (not shown in FIG. 5) between the plate P2 and the ground/low frequency signal contacts 23, may be selected to provide a capacitance C_{g} between the plate P2 and the ground/low frequency signal contacts 23.

As shown in FIGS. 6-8, the ungrounded structure 10 may be an electrically conductive material disposed adjacent to one or more signal contacts 21 and to one or more ground/low frequency signal contacts 23. The electrically conductive material may be formed as two pairs of parallel, non-shielding plates P1, P2 and P3, P4. The plates P1-P4 may be disposed to form a ring of parallel plates that circumscribes an array of the first and second pluralities of contacts.

With regard to FIG. 6, and as described in detail above, the distance between the plate P1 and the ground/low frequency signal contacts 23, as well as the dielectric material (not shown in FIG. 6) between the plate P1 and the ground/low frequency signal contacts 23, may be selected to provide a capacitance C_{g} between the plate P1 and the ground/low frequency signal contacts 23. Similarly, the distance between the plate P2 and the ground/low frequency signal contacts 23, as well as the dielectric material (not shown in FIG. 6) between the plate P2 and the ground/low frequency signal contacts 23, may be selected to provide a capacitance C_{g} between the plate P2 and the ground/low frequency signal contacts 23.

With regard to FIG. 7, and as described in detail above, the distance between the plate P1 and the ground/low frequency signal contacts 23, as well as the dielectric material (not shown in FIG. 7) between the plate P1 and the ground/low frequency signal contacts 23, may be selected to provide a capacitance C_{g1} between the plate P1 and the ground/low frequency signal contacts 23. Similarly, the distance between the plate P2 and the ground/low frequency signal contacts 23, as well as the dielectric material (not shown in FIG. 7) between the plate P2 and the ground/low frequency signal contacts 23, may be selected to provide a capacitance C_{g1} between the plate P2 and the ground/low frequency signal contacts 23.

The distance between the plate P3 and a first of the outer ground/low frequency signal contacts 23, as well as the dielectric material (not shown in FIG. 7) between the plate P3 and the first outer ground/low frequency signal contact 23, may be selected to provide a capacitance C_{g2} between the plate P3 and the first outer ground/low frequency signal contact 23. Similarly, the distance between the plate P4 and a second of the outer ground/low frequency signal contacts 23, as well as the dielectric material (not shown in FIG. 7) between the plate P4 and the second outer ground/low frequency signal contact 23, may be selected to provide a capacitance C_{g2} between the plate P4 and the second outer ground/low frequency signal contact 23.

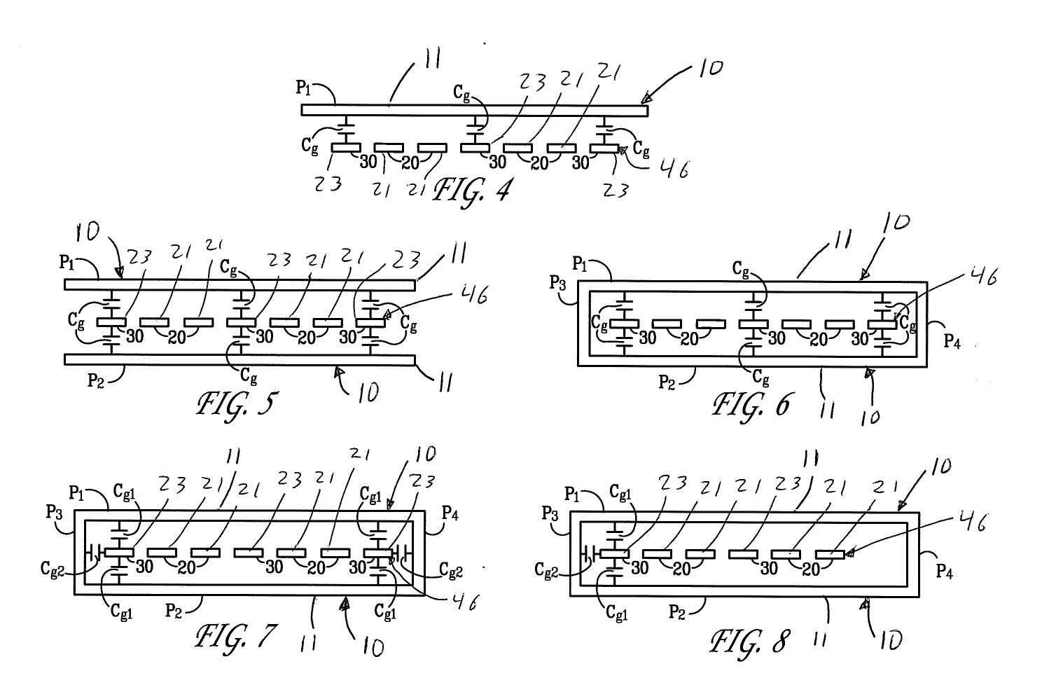

With regard to FIG. 8, and as described in detail above, the distance between the plate P1 and the ground/low frequency signal contacts 23, as well as the dielectric material (not shown in FIG. 8) between the plate P1 and the ground/low frequency signal contacts 23, may be selected to provide a capacitance C_{g1} between the plate P1 and the ground/low frequency signal contacts 23. Similarly, the distance between the plate P2 and the ground/low frequency signal contacts 23, as well as the dielectric material (not shown in FIG. 8) between the plate P2 and the ground/low frequency signal contacts 23, may be selected to provide a capacitance C_{g1} between the plate P2 and the ground/low frequency signal contacts 23.

The distance between the plate P3 and the outer ground/low frequency signal contact 23, as well as the dielectric material (not shown in FIG. 7) between the plate P3 and the first outer ground/low frequency signal contact 23, may be selected to provide a capacitance C_{g2} between the plate P3 and the first outer ground/low frequency signal contact 23. As shown in FIG. 8, there is no outer ground contact adjacent to the plate P4.

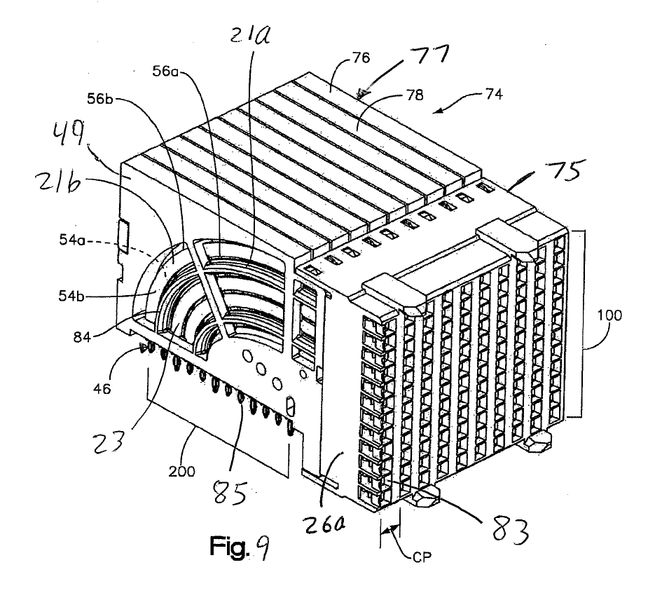

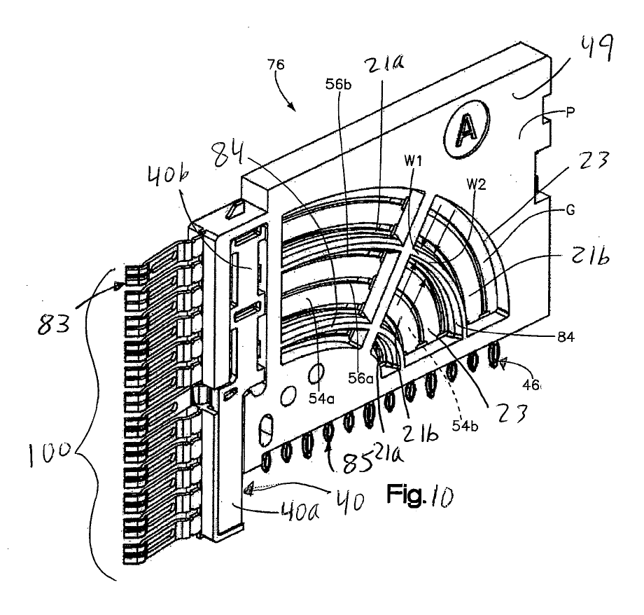

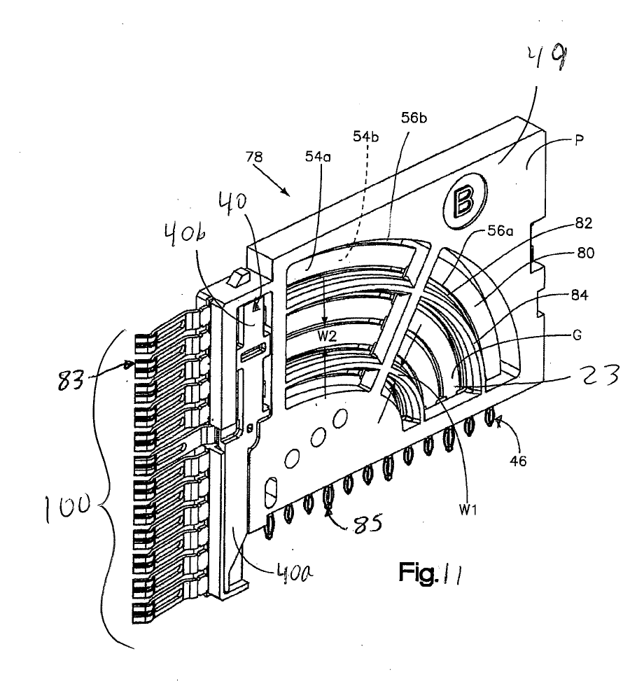

Referring now to FIGS. 9-11, an electrical connector such as a right angle connector 74 can include a dielectric or electrically insulative connector housing 75 that supports plurality of leadframe assemblies 77, which can include alternatingly arranged first leadframe assemblies 76 that each define a first pattern of electrical contacts 46 and second leadframe assemblies 78 that each define a second pattern of electrical contacts 46. Thus, it can be said that the connector housing 75 supports the plurality of electrical contacts 46 of the leadframe assemblies 77. It should be appreciated that the electrical connector 74 can be configured as desired so as to support a plurality of electrical contacts 46 that are configured to place a first electrical component in electrical communication with a second electrical component. The electrical contacts 46 define respective mating ends 83 and opposed mounting ends 85

In accordance with one embodiment, the electrical contacts 46 can define an open pin field or may be assigned signal contacts and ground contacts so as to define a repeating signal-signal-ground (S-S-G) pattern along the column direction in the respective leadframe assemblies 77. The contact pattern of a given leadframe assembly 77 can be offset with respect to the contact pattern of an adjacent leadframe assembly 77. For instance, each of the first plurality leadframe assemblies 76 can define a repeating S-S-G pattern along the column direction from one end of the column to the other. Each of the second plurality of leadframe assemblies 78 can define a repeating G-S-S pattern along the same column direction from the same one end of the column to the other. It should be appreciated that the electrical contacts 48 of each leadframe assembly 44 can be provided in any pattern as desired, to include low frequency signal contacts in place of one or more ground contacts 23, and the electrical contact patterns of adjacent leadframe assemblies 44 can be offset or aligned with each other as desired. Alternatively, the leadframe assemblies 76 and 78 can define identical patterns of electrical contacts 46. Each leadframe assembly 57 includes a dielectric or electrically insulative leadframe housing 49 that supports the electrical contacts 46. For instance, the leadframe housing 49 can be overmolded onto the electrical contacts 46, the electrical contacts 46 can be stitched into the leadframe housing 49, or the leadframe housing 49 can alternatively support the electrical contacts 46 in any manner as desired. The leadframe housings 48 can be made of any suitable material, such as plastic P.

The right angle electrical connector 74 is shown as right angle receptacle connector, but right angle electrical connector 74 may also be a right angle header connector. The electrical contacts 46 can define at least one broadside 54a, a second broadside 54b opposite the at least one broadside 54a, and two opposed edges 56a and 56b that are shorter than the broadsides 54a and 54b as described above. The right angle electrical connector 74 also defines a mating interface 100 and a mounting interface 200 that is oriented substantially perpendicular to the mating interface 100. Alternatively, the mating interface 100 and the mounting interface can be oriented substantially parallel to each other, such that the electrical connector 75 can be configured as a vertical or mezzanine electrical connector.

Two adjacent signal contacts 21a and 21b of the plurality of electrical contacts 46 may define a differential signal pair, such as an edge coupled differential signal pair. A ground/low frequency signal contact 23 may be disposed adjacent to the edge coupled differential signal pair, and thus can be disposed between a pair of adjacent differential signal pairs. The leadframe assembly 76 can include a rib 84 that extends along at least a portion of the length (for instance fifty percent or more of the total length between the mating end 83 and mounting end 85) of the physically shorter signal contact 21a of the signal contacts 21a and 21b. Accordingly, in this embodiment, without being bound by theory, it is believed that the rib 84 causes electrical signals to travel more slowly through the physically shorter signal contact 21a as opposed to the physically longer signal contact 21b, thereby increasing the effective electrical length of the physically shorter signal contact 21a between the mating end 83 and the opposed mounting end 85, and adjusting for inter-pair skew. The rib 84 may constructed from a dielectric plastic such as a liquid crystal polymer, electrically non-conductive magnet absorbing material, or other suitable material. In accordance with one embodiment, the rib 84 has a dielectric constant greater than that of air. The rib 84 may also be constructed from an electrically conductive magnetic absorbing material that is electrically insulated from other signal or ground contacts by insulative plastic P. Each rib 84 may each have a first width W1 that is less than, equal to, or greater than second width W2 of a broadside surface 54A, 54B of one of the plurality of electrical contacts 46.

The first right angle leadframe assembly 76 is shown in FIG. 12 and the second right angle leadframe assembly 78 is shown in FIG. 13. At least one or both of the first right angle leadframe assemblies 76 and the second right angle leadframe assemblies 78 may include a ungrounded plate 40 of the type described above that spans across one or more the signal contacts 21 and one or more of the ground/low frequency signal contacts 23. The ungrounded plate 40 can be shaped to avoid physical contact with the signal contacts 21, and further shaped to avoid direct physical contact with the ground/low frequency signal contacts 23. The ungrounded plate 40 can be supported by the leadframe housing 49, for instance proximate to and substantially parallel with the mating interface 100. The ungrounded plate 40 can include first and second segments 40a and 40b that are jogged with respect to each other, and thus define different distances with respect to the mating interface 100. The ungrounded plate 40 may be electrically insulated from the ground/low frequency signal contacts 23 via bulks of electrically insulative material 50, which may be plastic, for example (see, e.g., FIG. 3A). The bulks of electrically insulative material 50 may be disposed between the ungrounded plate 40 and the ground/low frequency signal contacts 23. Thus, the ungrounded plate 40 may be located adjacent to at least one of the differential signal pairs (or all of them) without making electrical contact with any of the signal contacts 21. At the same time, the ungrounded plate 40 may be insulated from the adjacent ground/low frequency signal contacts 23. While the ungrounded plate 40 can be spaced farther from the signal contacts 21 than the ground/low frequency signal contacts 23 as described above, the ungrounded plate 40 can alternatively be spaced the same distance from the signal contacts 21 and the ground/low frequency signal contacts 23.

In accordance with one embodiment, the ungrounded plate 40 can be conductive, that is, can establish an electrical flow path. For instance ungrounded plate 40 can be made from a conductive lossy material, such as carbon-impregnated plastic, and thus can define an electrically conductive magnetic absorbing material. Alternatively, the ungrounded plate 40 can be conductive but non-magnetically absorbing, such as metallic. Alternatively still, the ungrounded plate 40 can be magnetically absorbing and non-conductive. For instance, the electrically conductive material of the ungrounded plate 40 can be a ferrite-infused plastic. It should be appreciated that while the ferrite-infused plastic does not cause the ungrounded plate 40 to be electrically conductive, that is establish an electrically conductive flow path, the ferrite infusion causes the ungrounded plate 40 to be made from a conductive material. Accordingly, whether the ungrounded plate 40 is conductive or non-conductive, the ungrounded plate 40 can be capacitively coupled to the ground/low frequency signal contacts 23. It should be appreciated, as described above, that the second plurality of electrical contacts 30 can be configured as signal contacts, in which case the ungrounded plate 40 can be capacitively coupled to signal contacts (see FIG. 3A).

It should be understood that the embodiments depicted herein are merely examples provided for illustrative purposes. Other embodiments are contemplated. For example, the ungrounded ground structure may be formed such that the respective capacitances between the ungrounded structure are different from one another, either by altering the respective distances between the ungrounded non-shielding structure and the respective ground or low frequency signal contacts or the high frequency signal contact, by disposing different dielectric materials between the ungrounded non-shielding structure and the respective ground or low frequency signal or the high frequency signal contacts, by disposing different volumes dielectric materials between the ungrounded non-shielding structure and the respective ground or low frequency signal or high frequency signal contacts, or by any combination of the foregoing. Similarly, the ungrounded non-shielding structure may be formed such that the respective capacitances between the ungrounded non-shielding structure and the several signal contacts are different from one another, for example, by altering the respective distances between the ungrounded non-shielding structure and the respective signal contacts.

What is claimed:

1. An electrical connector, comprising:
a connector housing supporting a first plurality of electrical contacts and a second plurality of electrical contacts;
an ungrounded structure that extends over at least two of the first plurality of electrical contacts and at least two of the second plurality of electrical contacts,
wherein the ungrounded structure makes no physical contact with the first and second pluralities of electrical contacts, second broadsides of the second plurality of electrical contacts are spaced a first distance from the ungrounded structure, first broadsides of the first plurality of electrical contacts are spaced a second distance from the ungrounded structure, and the first distance is less than the second distance.

2. The electrical connector as recited in claim 1, wherein each of the first plurality of electrical contacts comprises signal contacts, and each of the second plurality of electrical contacts comprises ground contacts or low frequency signal contacts.

3. The electrical connector of claim 2, wherein the signal contacts define at least one differential signal pair.

4. The electrical connector of claim 1, wherein the ungrounded structure comprises a pair of parallel plates.

5. The electrical connector of claim 4, wherein the ungrounded structure comprises a two pairs of parallel plates.

6. The electrical connector of claim 5, wherein the ungrounded structure comprises a ring of parallel plates.

7. The electrical connector of claim 2, wherein the ungrounded structure comprises a first plate adjacent to a first of the ground contacts, and a second plate adjacent to a first differential pair of the signal contacts.

8. The electrical connector of claim 7, wherein the ungrounded structure comprises a third plate extending between the first plate and the second plate.

9. The electrical connector of claim 1, wherein the ungrounded structure is an electrically conductive, magnetic absorbing material.

10. The electrical connector of claim 1, wherein the at least two of the second plurality of electrical contacts are capacitively coupled to the ungrounded structure.

11. The electrical connector of claim 3, wherein a first capacitance is provided between one of the at least two second plurality of electrical contacts and the ungrounded structure and a second capacitance is provided between the differential signal pair and the ungrounded structure.

12. An electrical connector, comprising:
a differential signal pair that carries high frequency signals of about 2 GHz to about 10 GHz;
at least two electrical contacts each selected from the group comprising ground contacts that do not carry a signal and low frequency signal contacts that carry a low frequency signal; and
an ungrounded structure that extends over the differential signal pair and the at least two electrical contacts without physically touching the differential signal pair and without touching the at least two electrical contacts,
wherein portions of the high frequency signals that undesireably radiate from the differential signal pair are received by an adjacent one of the at least two electrical contacts, the undesirably radiated high frequency signals pass through a first capacitive gap defined between one of the two electrical contacts and the ungrounded structure, and the undesirably radiated high frequency signals are transferred to the ungrounded structure.

13. The electrical connector of claim 12, wherein the low frequency signal is 0 Hz to 100 MHz and the low frequency signal does not pass through the first capacitive gap.

14. The electrical connector of claim 12, wherein the ungrounded structure is an electrically conductive, magnetic absorbing material.

15. The electrical connector of claim 12, wherein the at least two electrical contacts are electrically shorted together when the when the high frequency signal is about 2 GHz to about 10 GHz.

16. The electrical connector of claim 15, wherein the low frequency signal is 0 Hz to 100 MHz and the low frequency signal does not pass through the first capacitance.

17. An electrical connector, comprising:
an array of electrical contacts comprising:
a first plurality of electrical contacts comprising a differential signal pair that is configured to carry high frequency signals between and including about 2 to about 10 GHz; and
a second plurality of electrical contacts comprising at least two electrical contacts selected from the group comprising at least one of ground contacts and low frequency signal contacts, wherein the at least one of ground contacts are configured to carry no signal frequency and the low frequency signal contacts are configured to carry frequencies of approximately 0 Hz to 100 MHz; and
a magnetic absorbing material that extends over the differential signal pair and the at least two electrical contacts,
wherein the magnetic absorbing material does not physically touch the at least two electrical contacts but is capacitively coupled to the two electrical contacts so as to define a first capacitance between each of the two electrical contacts and the magnetic absorbing material, wherein the at least two electrical contacts are shorted together when the frequency of the high frequency signals overcomes the first capacitance.

18. The electrical connector of claim 19, wherein the magnetic absorbing material is electrically conductive.

19. An electrical connector, comprising:
a connector housing supporting a first plurality of electrical contacts and a second plurality of electrical contacts;
a non-shielding ungrounded structure that extends over at least two of the first plurality of electrical contacts and at least two of the second plurality of electrical contacts,
wherein the ungrounded structure makes no physical contact with the first and second pluralities of electrical contacts.
